(19) United States
(12) Patent Application Publication
(10) Pub. No.: US 2002/0146023 A1
(43) Pub. Date: Oct. 10, 2002

(54) Transport stream multiplexer utilizing smart FIFO-meters

(76) Inventor: Regan Myers, San Diego, CA (US)

Correspondence Address: Kathleen L. Connell, Brown, Martin, Haller & McClain, 1660 Union Street, San Diego, CA, 92101-2926, US

(21) Appl. No.: 10/043,983

(22) Filed: Jan. 9, 2002

Related U.S. Application Data
(60) Provisional application No. 60/260,414, filed on Jan. 9, 2001.

(51) Int. Cl. H04L 12/28; H04L 12/56

(52) U.S. Cl. 370/412; 370/537

(57) ABSTRACT

An MPEG-2 transport stream multiplexer architecture includes an input-buffered multiplexer with a simple Longest Queue First (LQF) arbitration algorithm which is enhanced by use of intelligent buffer metering and flow control circuitry. The use of intelligent buffer metering allows the multiplexer to implement maximum and minimum bandwidth guarantees on a per-channel basis. The simplicity and inherent parallelism of this architecture allows for an efficient hardware implementation,

### CROSS-REFERENCES TO RELATED APPLICATIONS

This application claims the benefit of priority of U.S. provisional application Serial No. 60/260,414 filed Jan. 9, 2001, which is incorporated herein by reference in its entirety.

### BACKGROUND OF THE INVENTION

1. Field of Invention

This invention relates generally to multiplexers for broadcasting data, and more specifically a smart multiplexer accepting a multiple of input transport streams of data and outputting a single output transport stream based upon a number of quality of service guarantees.

2. Background

Multiplexers are increasingly important components in MPEG-2 broadcast systems. Multiplexers allow the creation of multiple-channel per carrier (MCPC) transports streams and the inclusion of local data services in the broadcast stream. Multiplexers that include the ability to remove programs or program elements as well as combine program streams make it possible to create custom MCPC streams for local broadcast markets without expensive and quality degrading decoding and re-encoding. Such multiplexers are commonly referred to as Re-multiplexers, Add-and-Drop Multiplexers or Transport Stream Groomers. If the multiplexer supports some method of flow control, then “opportunistic” data can be inserted into a pre-existing stream to effectively make use of all free, i.e., unused, bandwidth.

Multiplexers for broadcast systems typically receive input data streams from data servers, e.g., a Moving Picture Experts Group (MPEG) video encoders, MPEG audio encoders, or Internet protocol encapsulaters (IPE). Due to the nature of the MPEG-2 compression scheme, encoders cannot always produce a constant output bit rate for the compressed video and audio. Video encoders operating in Variable Bit Rate (VBR) mode keep the quality of the compressed video constant by continuously changing the output bit rate to match the complexity of the video to be encoded. In order to convert the variable rate stream created by the encoder to a constant rate stream suitable for a modulator, null packets are inserted as necessary to ensure that the combined output data rate is a constant level. The resulting output data stream contains an amount of video data that varies over time, and an inversely varying amount of null packets.

Referring to FIG. 2, a fixed bandwidth 54 is available to most digital video broadcasters for broadcasting video data 50. For example, the Advanced Television Systems Committee (ATSC) standards mandate that broadcasters transmit a constant output data rate of exactly 19.392658 Mbps of data. As a result, null packets 58 must be inserted to fill any bandwidth not filled by a video packet 52 at time t. For simplicity, audio and Program Specific Information/Service Information (PSI/SI) data, which typically make up a relatively small portion of the total transport stream bandwidth, have not been included in the illustration. Null packets 58 that are broadcast across the fixed bandwidth 54 represents a waste of the bandwidth. To eliminate this waste, and to increase revenue from their fixed bandwidth asset, broadcasters may insert other data services into the transport stream by replacing null packets with data after the video encoder.

Null packets do not contain any data, and therefore, the bandwidth utilized by null packets is wasted. To eliminate this waste, multiplexer systems may replace the null packets with data packets requested from an IPE. FIG. 4 illustrates a solution for utilization of unused bandwidth in a video data stream 50. Opportunistic data packets 64 are inserted in place of the bandwidth filled with null packets 58. For optimum operation, an IPE must send exactly as many additional opportunistic data packets as there were null packets in the original video data stream. If the IPE sends too few opportunistic packets, then the output stream from the multiplexer must contain some null packets. If the IPE sends too many data packets, the multiplexer must drop packets, causing possible loss of either video content or opportunistic data content. The exact number of null packets depends on the video content. Thus, it is impossible for the multiplexer to know, in advance, the number of data packets the IPE must send to replace the null packets. To solve this problem, typical multiplexers of the prior art utilize a flow control protocol in accordance with the SMPTE 325M standard for Opportunistic Data Broadcast Flow Control. The protocol allows the multiplexer to request exactly the correct amount of data packets form the IPE to completely fill the output stream without dropping any data packets.

Multiplexers suffer from the problem of increasing complexity as the number of input ports increase. In particular, the difficulty of deciding what data packet to forward to the next output increases as the number of possible packet sources increases. The decision of what packet to forward may be based upon a number of factors such as the number of packets that are waiting in each buffer and the length of time the packets have been waiting in each buffer, i.e., latency.

The number of waiting packets is generally reported to an arbitration logic by a meter that simply reports the total number of bytes or packets present in the buffer. A basic multiplexer architecture 10 is illustrated in FIG. 1. Unlike Internet Protocol (IP) data, which may be transmitted out of order, data such as MPEG-2 data must be received in its original sequence. Thus, it is not desirable to re-order packets in an MPEG-2 transport stream, and first-in first-out (FIFO) buffers 20, 38 are typically used. In the basic multiplexer architecture 10, each input channel 12, 30 is assigned a single FIFO buffer 20, 38. Data packets are routed to each input channel 12, 30 from data servers 6, 8 on input lines 40, 42.

The input router 16, 34 of each input channel 12, 30 has the capability of implementing a variety of functions. The input router 16, 34 may modify a packet identifier (PID) of any incoming data packet in the case that the data packet is present with the same PID at multiple inputs. To conserve maximum bandwidth, the input router 16, 34 of the prior art may drop some or all null packets. If there is insufficient space in the buffer 20, 38 to hold a complete data packet, as indicated by the FIFO meter 18, 36, the input router 16, 34 will drop the entire packet. The input router 16, 34 may also perform stream grooming functions by selectively dropping packets with a specified PID.

The buffer 20, 38 fullness measure is forwarded from the FIFO meters 18, 36 to the arbitration logic 22. Based upon the input from the FIFO meters 18, 36, the arbitration logic 22 sends a select control signal to a multiplexer 24 to select a single output from among the data buffers 20, 38. Buffer fullness may also be forwarded to optional flow-control logic 14, 32. Flow control 14, 32 is used between the multiplexer 24 and a controllable data server 8 to request more data as the buffers 20, 38 output data. The flow control logic 14, 32 may request more or less data from the data server based on the fullness of the buffer 20, 38. As the buffer 20, 38 begins to empty, the flow-control logic 14, 32 requests more data from the data server 8 to increase the buffer level. As the buffer 20, 38 fills up, the flow-control logic 14, 34 will request less data from the data server 6, 8 and the buffer level will begin to decrease.

A typical algorithm utilized by the arbitration logic 22 of the basic multiplexer architecture 10 is the Longest Queue First (LQF) algorithm. The LQF algorithm is a common arbitration scheme, and is often used in routers and multiplexers. The LQF algorithm takes data from the buffer 20, 38 having the most data. This algorithm has the advantages of simplicity, linear complexity, and efficient use of all available buffer space. Because the algorithm consists of a simple search for the maximum element of a list, i.e., data from the FIFO meters 18, 36, at most N-1 level comparisons are required for N input channels. Because data is consistently taken from the longest buffer, the data levels in the other buffers increase until they reach approximately the same level. This algorithm spreads the data load evenly among all buffers 20, 38.

The basic multiplexer architecture 10, of FIG. 1, is sufficient for deciding which data packets to forward based upon the number of packets that are waiting in each buffer 20, 38. However, a need remains for a smart architecture which may output data packets based upon a variety of factors including a priority of non-opportunistic and opportunistic data, the number of packets waiting in each of the active buffers, the length of time the packets have been waiting in each of the buffers, as well as the quality of service (QoS) guarantees for each input channel.

### SUMMARY OF THE INVENTION

FIFO meter for outputting opportunistic data packets to effectively make use of all unused bandwidth.

It is another advantage to provide a smart multiplexer architecture for outputting opportunistic data based upon quality of service (QoS) guarantees for each input channel including fixed data rate insertion, maximum data rate insertion, minimum data rate insertion, and minimum null rate insertion.

It is yet another advantage to provide a dynamic multiplexer architecture which is configurable to further specify opportunistic data packet transmission based upon the length of time the packets have been waiting in the buffer.

Another advantage is to provide a dynamic multiplexer which includes the previous advantages and the implementation of quality of service guarantees at a negligible increase in the cost and in the complexity of the arbitration logic of the multiplexer.

In an exemplary embodiment of the present invention, a smart multiplexer implements maximum and minimum bandwidth guarantees on a per-channel basis utilizing smart FIFO meters for each channel. By making the FIFO meters of the multiplexer more intelligent, quality of service guarantees are provided without increasing the complexity of the arbitration logic of the multiplexer. Each smart FIFO meter is able to raise or lower the relative priority of data in its channel buffer based upon specific criteria such as the quality of service guarantees.

In prior art multiplexers, the actual amount of data in the buffer is reported to the flow control and arbitration logic, and the data is output based upon the priority and the amount of data present in each buffer. The smart FIFO meter of the exemplary embodiment, consistent with the applicable priorities and criteria for its channel, reports a fictitious amount of data in the buffer to the flow control and arbitration logic in order to increase or decrease the priority of its associated buffer. The reported amount of data, rather than the actual amount of data in the buffer, allows each smart FIFO meter to mandate the amount of data that the flow control requests from the server and the amount of data that the arbitration logic will remove from the buffer associated with each smart FIFO. The exemplary embodiment of the invention provides a user input for enabling or disabling flow control. If flow control is off for all channels, the multiplexer behaves like a traditional multiplexer.

In the exemplary embodiment of the present invention, the multiplexer includes at least one video data channel, such as MPEG-2 digital video channel or a similar “non-opportunistic” data channel. Video data, such as MPEG transport streams, consists of a continuous stream of packets, wherein each transport packet includes a number of information fields in addition to the data to be transmitted. The non-opportunistic data typically is given priority for transmission, and therefore, the arbitration logic is prompted by the smart FIFO meter to remove the video data from the buffer as it enters the buffer. Opportunistic data, e.g., data from local data services, is output in the bandwidth not utilized by the video data. Insertion of opportunistic data into this remaining bandwidth is implemented utilizing the smart FIFO meters, with each smart FIFO meter establishing a priority for the data in its buffer. Although the video data is given priority, as discussed below, alternate embodiments of the invention may override this priority to meet the requirements of quality of service guarantees.

### Quality of Service Guarantees

Utilizing a smart FIFO meter, the exemplary embodiment of the present invention is able to implement quality of service guarantees. The quality of service guarantees may be specified by a user and include full bandwidth use by insertion of opportunistic data, a fixed opportunistic data rate insertion guarantee, a maximum opportunistic data rate insertion limit, a minimum data rate insertion guarantee, and a minimum null rate insertion guarantee. Each quality of service guarantee may be implemented individually or in combination to allow broadcasters to specify the composition of their transport streams to match their needs.

Opportunistic Data Insertion. The premise of opportunistic data is that there exists at least one stream of data with an unknown or variable amount of unused bandwidth in the form of null packets. Replacing the null packets with other packets containing data makes profitable use of the unused bandwidth. Because the number of null packets is not known in advance, flow control utilizing defined protocol requests precisely the correct number of data packets to replace all of the null packets. The flow control logic monitors the amount of free space in the input buffer. Whenever the FIFO buffer has space, the flow control logic sends a request for exactly enough packets to fill the input buffer. When packets are removed from the buffer, the level of the buffer decreases, and the flow control logic generates a new request to the data server.

This above described method of flow control presents a problem for LQF arbitration systems. Specifically, because the FIFO meter with flow control is always kept full, it is always the longest queue with the highest priority. Thus, the data from other data channels will not be output from the multiplexer. The smart FIFO meters of the exemplary embodiment of the present inventions solve this problem by disabling flow control on the non-opportunistic channels and enabling flow control on the opportunistic channels only. The opportunistic channels with flow control always report a buffer queue of one packet or less to the arbitration logic. Then, if any other non-opportunistic buffers have more than one packet present, the LQF logic will give these channels priority over the flow-controlled buffers. Data is only fed from the opportunistic buffers when all other non-opportunistic channel buffers in the multiplexer have less than one packet present.

Fixed Data Rate Insertion. When the characteristics of the video encoder are well known, so that there is always a guaranteed amount of null packets in the stream, some of the bandwidth may be recovered by inserting opportunistic data at a fixed rate. An example of such a situation may occur if a single Standard Definition Television (SDTV) stream is encoded at 15 Mbps, and then broadcast at the Advanced Television System Committee (ATSC) rate of 19.39 Mbps. Even after the inclusion of audio and other data, approximately 4 Mbps of bandwidth is available. Fixed data rate insertion may implemented by setting the video output of the IPE at a rate that is always lower than the guaranteed amount of null packets present in the video stream. Once the non-opportunistic data buffer indicates one or less packet of information in the queue, the opportunistic data channel is given priority to fill the remaining bandwidth. However, this implementation wastes bandwidth, as null packets 58 must be inserted into the data stream whenever the amount of video data 60 is at less than the known maximum 62, and does not allow very much data to be inserted when the peak video data rate 50 is close to the overall rate. The smart FIFO of the exemplary embodiment provides a simpler means for fixed data rate insertion by utilizing a smart FIFO meter channel set for one of a maximum data rate insertion or a minimum data rate insertion as described below.

Maximum Data Rate Insertion. The exemplary embodiment of the present invention allows for the insertion of opportunistic data at no greater than a maximum bandwidth. In this embodiment, the user sets a maximum data rate on an opportunistic channel. The maximum data rate sets an upper limit on the amount of data the multiplexer requests from the IPE. An example default limit is set to 216 Mbps, which is the maximum channel capacity of an digital video broadcasting asynchronous serial interface (ASI) link. This effectively means that there is no limit on the amount of data that is inserted by the multiplexer into the output transport stream, i.e., full opportunistic data insertion. If the maximum data rate is set lower, the multiplexer inserts data into the stream until the maximum data rate is reached.

The Smart FIFO meter of the exemplary embodiment implements maximum data rate insertion by monitoring the amount of data being removed from its buffer. If the data is being removed at more than the maximum rate, the smart FIFO meter reports to the flow control that its buffer contains more data than is actually in the buffer. As a result, the flow control unit for that buffer request less data from the data server, and only the user-specified maximum data rate is available to leave that buffer. If the maximum data rate is reached and bandwidth is still available in the transport stream, then null packets are inserted to fill the bandwidth.

The exemplary embodiment of the transport stream multiplexer supports multiple streams under flow control. Thus, the maximum data rate limit is useful when multiple opportunistic channels are connected to the multiplexer. The maximum data rate ensures that particular channel is limited as to the amount of bandwidth that it can utilize.

The maximum data rate limit is also useful with latency sensitive opportunistic data. If there is a sudden drop in the amount of video data present in the stream, opportunistic data insertion with no maximum rate will use the full bandwidth available. This situation can empty the buffers in the IPE. More data packets cannot be transmitted to the multiplexer until new data arrives over the Ethernet interface. By limiting the peak rate at which opportunistic data is transmitted, the instantaneous rate of data transmission is smoothed out, and the latency variation of the opportunistic data is improved.

Minimum Data Rate Insertion. The transport stream multiplexer of the exemplary embodiment also includes a minimum data rate guarantee for opportunistic data. For some applications, the opportunistic data being inserted may require a minimum transmission rate. This is not possible with the original transport stream composition as the non-opportunistic data receives priority. In the exemplary embodiment, specifying a channel for minimum data rate insertion allows the opportunistic data to pre-empt the video data, or another opportunistic stream, to ensure that the minimum rate is being met. If more bandwidth is available after the minimum rate insertion, then the opportunistic data may expand to fill the available space.

For applications where a minimum amount of bandwidth is required for opportunistic data, a user sets a minimum data rate for a particular opportunistic data channel. The smart FIFO meter monitors the data leaving the buffer, and raises the priority of its buffer if the data is transmitted at less than the minimum rate. To raise the priority of its buffer, the smart FIFO meter reports to the arbitration logic that its buffer has more data, i.e., priority over the non-opportunistic data channel, until enough opportunistic data is removed to fill the minimum bandwidth. When the Smart FIFO meter detects that the requisite bandwidth has been filled, the priority of its buffer is lowered below that of the non-opportunistic channel.

Null Packet Insertion. Most video channels such as MPEG-2 transport streams maintain a constant output bit rate by filling any unused bandwidth with null packets. Null packets may be added to the output of the smart FIFO meter by creating a “virtual” null queue which contains only null packets. If the arbitration level output for the null queue is set to always report exactly one packet to the arbitration logic, then null packets will be inserted into the output data when the video and opportunistic data queues fall below the level of one packet. Thus, null packets are output only if no other queue contains a complete packet. This feature has an added benefit that no data is ever read from a queue that has less than one packet because the LQF logic will always give the null queue higher priority.

Minimum Null Rate Insertion. Another Quality of Service option provided by the exemplary embodiment of the transport stream multiplexer is a minimum null rate guarantee. A minimum null rate allows a pre-determined minimum level of null packets to be left in the output stream after opportunistic data insertion. This option is useful if bandwidth must be reserved for a downstream re-multiplexing state. For example, both a national broadcaster and its local affiliates may wish into insert opportunistic data into a video stream. By using the minimum null rate guarantee, the national broadcaster may ensure that a minimum level of space remains for each local broadcaster to insert its own data.

The minimum null packet rate also may be required for compatibility with some equipment. For example, a format converter that changes transport streams from one physical interface to another may add or remove null packets to make up the difference in data rates between the input and output interfaces. If such a converter is used, a minimum level of null packets in the streams may be required to allow data rate matching.

For applications where a minimum null packet rate is required, a user sets a minimum data rate for a particular opportunistic data channel which outputs null packets, only. The smart FIFO meter monitors the null packets leaving the buffer, and raises the priority of its buffer if the data is transmitted at less than the minimum null packet rate. To raise the priority of its buffer, the smart FIFO meter reports to the arbitration logic that its buffer has more data, i.e., priority over the other opportunistic data channels which always indicate a packet level of one or less, until a sufficient number of null packets are transmitted to fill the minimum null rate bandwidth. When the Smart FIFO meter detects that the requisite bandwidth has been filled, the priority of its null packet buffer is lowered below that of the opportunistic channels to allow the remaining bandwidth to be filled with opportunistic data.

### Smart FIFO Meter Architecture

The smart FIFO meters of the exemplary embodiment of the transport stream multiplexer are implemented in programmable logic controlled by a microprocessor or similar controller circuitry. Each smart FIFO meter includes an actual count block, a maximum count block, a maximum count rate generator, a minimum count block, a minimum count rate generator, and a level select block. In other embodiments of the invention, the components of the smart FIFO meter may be implemented in software, in firmware, in discrete hardware components, or any combination thereof.

The inputs to each smart FIFO meter include a read, write and reset input and three user-specified control variables. The read and write inputs correspond to the actual read and write pulses generated when data is clocked into or out of the FIFO buffer. In a software only implementation, an appropriate software signal indicating the entry or removal of data from a buffer may be substituted for read or write pulses from a physical FIFO buffer. The reset input is generated whenever the multiplexer system is reset, e.g., upon power up of the multiplexer, or upon a user initiated reset of the system. Three user-specified inputs, including the maximum rate, the minimum rate, and the flow control are utilized to establish the quantity of data to be reported to the arbitration logic via the arbitration level output. The first user-specified variable, the maximum rate input, establishes a maximum bandwidth limit for the smart FIFO meter channel. The minimum rate input establishes the minimum bandwidth guarantee for the channel. The flow control input enables or disables flow control for the data channel. When flow control is disabled, each smart FIFO meter reports the arbitration level as the actual amount of data in its buffer, and the multiplexer behaves as a traditional multiplexer.

Each smart FIFO meter has three separate outputs to indicate three different levels of data in the FIFO buffer. A first output of a free space value prompts the flow control logic to request data from the data server. A second output of an arbitration level is sent to the arbitration logic to specify a priority of the data in the buffer. A third output of an actual count is reported to the input router so that the router can determine whether the FIFO has sufficient space to accept another data packet.

When flow control is enabled for opportunistic data streams, the amount of data reported to the arbitrator is not more than one full packet, unless a minimum rate insertion is specified. The arbitration logic selects the next packet from the buffer with the most reported data. Since each flow-controlled buffer of opportunistic data reports one or less data packets, the non-opportunistic, e.g., video stream, will “win” the arbitration as long as it contains one or more data packets. Ties are awarded to the non-opportunistic channel. In other words, the flow-controlled buffer is selected by the arbitration logic only when the video buffer contains less than one full packet of data. If the non-opportunistic transport stream input rate and the multiplexer output rate are the same, the video buffer will be empty only when a null packet is sent with the video since null packets are blocked at the input router of the transport stream multiplexer and are not passed into the video buffer. When a minimum rate insertion is specified, the opportunistic data channel reports a higher level of priority to the arbitration logic to maintain priority over the video channel until the specified minimum bandwidth is satisfied.

The user-specified maximum and minimum rates are input to the maximum rate generator and the minimum rate generator for producing clock pulses for the maximum and minimum count blocks, respectively. The maximum and minimum clocks rates control the rates at which data can enter the FIFO buffer. Utilizing these clock rates, the smart FIFO meter maintains two meter level counts, a maximum and minimum data count, which indicate the amount of data that the channel would contain if the data were to enter the buffer at these clock rates. When either generator block pulses, the smart FIFO meter increments the appropriate maximum or minimum data count. When data is actually removed from the buffer, the smart FIFO meter decrements both data counts provided that the counts are above zero. In the exemplary embodiment of the invention, counts are never decremented when they are equal to zero. Thus, the counts are implicitly constrained to be greater than or equal to zero.

Actual Count Block. The actual count block calculates the correct number of bytes of data present in the FIFO buffer. The actual count block has inputs including the FIFO write, FIFO read and reset inputs, and an output of the actual count. The actual count output is determined by incrementing the count by one if there is a FIFO write input and no FIFO read input, and decrementing the count by one if there is a FIFO read input and no FIFO write input. If a reset is sensed, the counter of the actual count block is reset to zero. The actual count output is constrained to remain within the limits of the FIFO size. For example, for a FIFO buffer that holds up to 4095 bytes, the actual count can range between 0 and 4095.

Maximum Count Block. The maximum count block has inputs of the FIFO read, the reset, the actual count output from the actual count block, and a maximum rate generated from the maximum rate generator. The maximum count output is the hypothetical number of bytes that would be in the FIFO buffer if data continued to enter the buffer at the maximum rate. The maximum count block operates similarly to the actual count block except that the maximum rate input is used instead of the FIFO write signal. The maximum count is constrained to always be greater than or equal to actual count while remaining within the limits of the FIFO size. The actual count subtracted from the maximum count produces the free space output which is sent to the flow control logic to prompt the server to send additional data.

The maximum rate value acts as a limit on the incoming data rate by manipulating the value of the free space output as reported to the flow control logic. If data is being read out of the buffer at a rate less than the maximum data rate, as determined by the frequency of maximum rate generator, then the value of maximum count remains close to the maximum level of the FIFO. Therefore, the value of the free space output is close to the actual amount of free space in the buffer, and the flow control circuitry requests data to fill the free space accordingly.

If data is removed from the buffer at a rate greater than the maximum data rate, the value of the maximum count output begins to decrease. The decrease reduces the reported amount of free space, and therefore, requests from the flow control for more data is inhibited. With requests inhibited, the actual level of data in the buffer will begin to drop. As the buffer level drops, the LQF logic reduces the priority of that queue, thus reducing the rate that data is taken from the FIFO. When the data rate is reduced to below the maximum data rate, the maximum count and free space outputs will both begin to increase to allow more data to be placed in the buffer.

For streams which are not under flow control, a maximum rate may be enforced by passing the free space output to the input router. The input router may utilize the free space information to drop packets that do not fit into the buffer as reported by the smart FIFO meter. However, it should be noted that it generally is not desirable to drop random MPEG-2 transport packets.

Minimum Count Block. The minimum count block has inputs of the FIFO read, the reset, the actual count output from the actual count block, and a minimum rate generated from the minimum rate generator. The minimum count output is the hypothetical number of bytes that would be present in the FIFO buffer if data continued to enter the buffer at the minimum rate. The minimum count block is similar to the maximum count block, except that the minimum count output is constrained to be less than or equal to actual count, while remaining within the limits of the FIFO size.

By setting the minimum rate value to a number greater than zero, a guaranteed minimum bandwidth may be reserved for a data channel. As long as data is being read from the FIFO buffer faster than the minimum data rate, as determined by the frequency of the minimum rate generator, the value of the minimum count output will remain close to zero because it is being decremented at a faster rate than it is being incremented. The value of the arbitration level output will remain fixed at one packet, and the data channel will act opportunistically as described above.

If data is being read from the queue at a rate less than the minimum data rate, the minimum count output begins to increase. The minimum count continues to increase until it has reached a level high enough that the LQF arbitration logic gives the channel priority over the other channels of the multiplexer. Minimum count remains at the high level until enough data has been removed from the queue to bring the aggregate rate back above the prescribed minimum rate.

Level Select block. The level select block has an input of the minimum count output from the minimum count block, the actual count output from the actual count block, and the flow control enable input. The level select block acts as a multiplexer to set the arbitration level to a correct, i.e., desired, priority value for output to the arbitration logic. If flow control is off, the arbitration level output equals the actual count, and the smart FIFO meter acts in the same manner as a simple FIFO meter of the prior art. If flow control is enabled, and the actual count is less than the known size of a transport packet, e.g., a MPEG-2 transport packet is 188 bytes, then the arbitration level output is set to zero. If flow control is enabled and actual count is greater than or equal to the known size of a transport packet, then the arbitration level output is set to the greater of known packet size and minimum count output of the minimum count block.

### BRIEF DESCRIPTION OF THE DRAWINGS

The present invention will be better understood from the following detailed description of an exemplary embodiment of the invention, taken in conjunction with the accompanying drawings in which like reference numerals refer to like parts and in which:

FIG. 1 is an illustration of a multiplexer of the prior art;

Figure 2 is an illustration of an original transport stream composition with null packet insertion;

FIG. 3 is a block diagram of the smart FIFO meter of a preferred embodiment of the present invention;

FIG. 4 is an illustration of opportunistic data insertion;

FIG. 5 is an illustration of fixed rate data insertion;

FIG. 6 is an illustration of transport stream composition after opportunistic data insertion with maximum data rate setting;

FIG. 7 is an illustration of transport stream composition after opportunistic data insertion with minimum data rate setting;

FIG. 8 is an illustration of transport stream composition after opportunistic data insertion with minimum null packet rate setting;

FIG. 9 is a block diagram of a transport stream multiplexer utilizing the smart FIFO meter of the preferred embodiment;

FIG. 10 is a block diagram of the input logic for a single channel of the transport stream multiplexer of FIG. 9; and

FIG. 11 is a clock diagram of the output logic of the transport stream multiplexer of FIG. 9.

### DETAILED DESCRIPTION OF THE DRAWINGS

The following detailed description utilizes a number of acronyms which are generally well known in the art. While definitions are typically provided with the first instance of each acronym, for convenience, the following list provides the acronyms and abbreviations and their respective definitions.

ACRONYM DEFINITION

| | |
|---|---|
| ASI | (digital video broadcasting) asynchronous serial |
| | interface |
| ATSC | Advanced Television Systems Committee |
| FIFO | First In First Out |
| FPGA | Field Programmable Gate Array |
| IP | Internet Protocol |
| IPE | Internet Protocol Encapsulater |
| MCPC | Multiple-Channel Per Carrier |
| MPEG | Moving Picture Experts Group |
| PID | Packet Identifier |
| PSI/SI | Program Specific Information/Service Information |
| QoS | Quality of Service |
| SDTV | standard definition television |
| SMPTE | Society of Motion Picture and Television Engineers |
| VBR | variable bit rate |

### Smart FIFO Meter Architecture

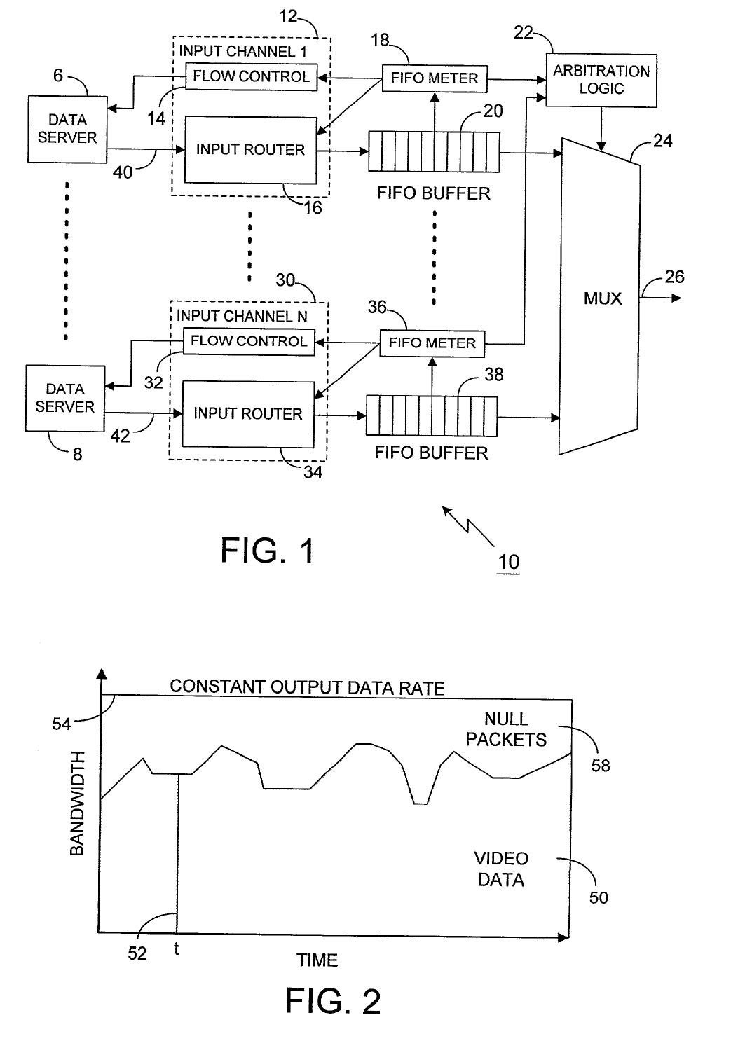

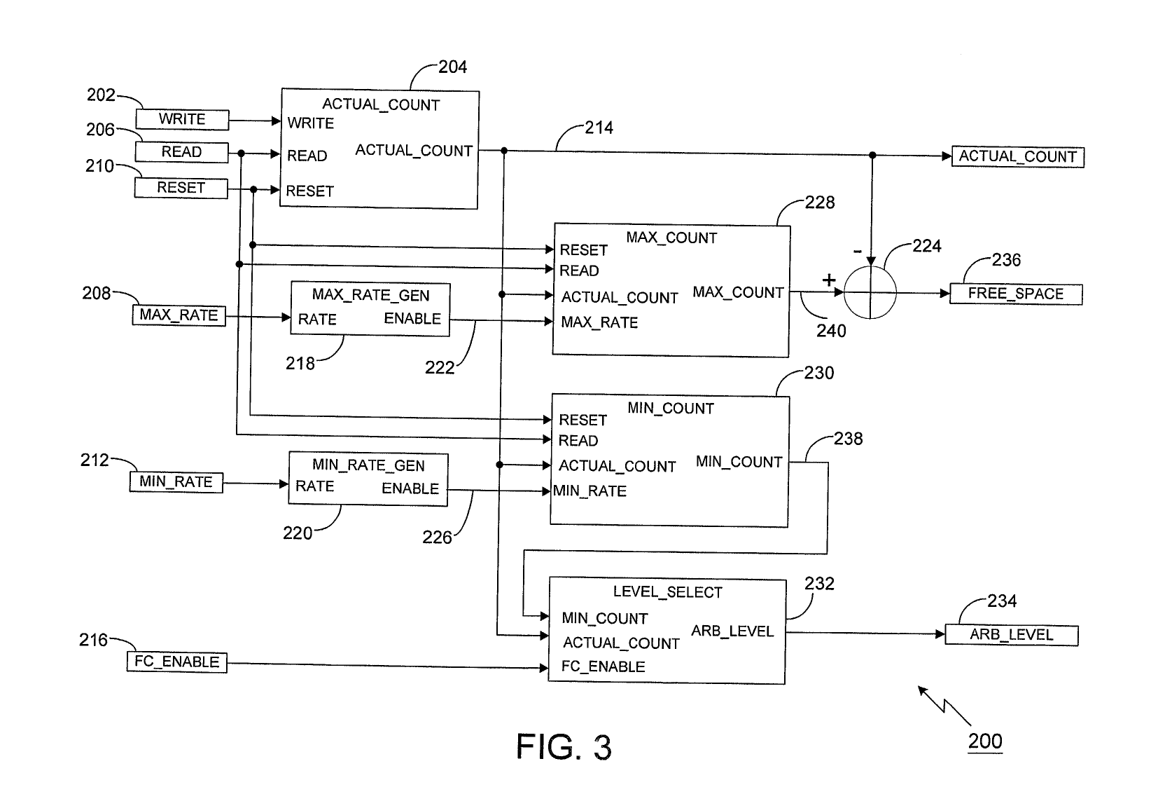

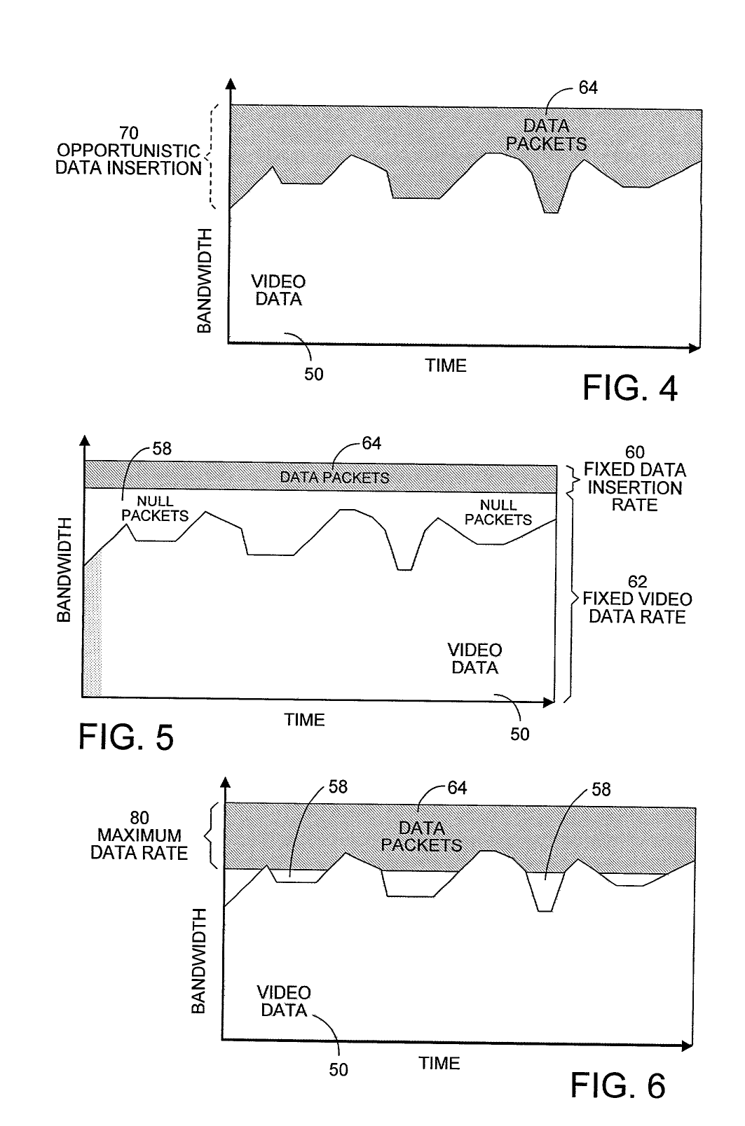

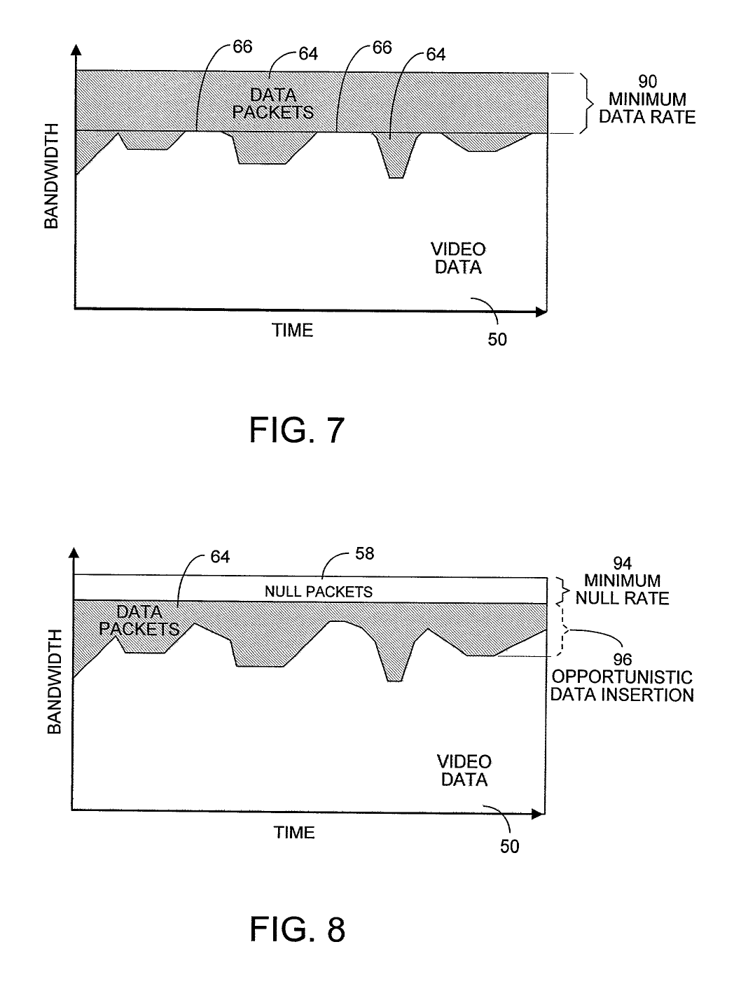

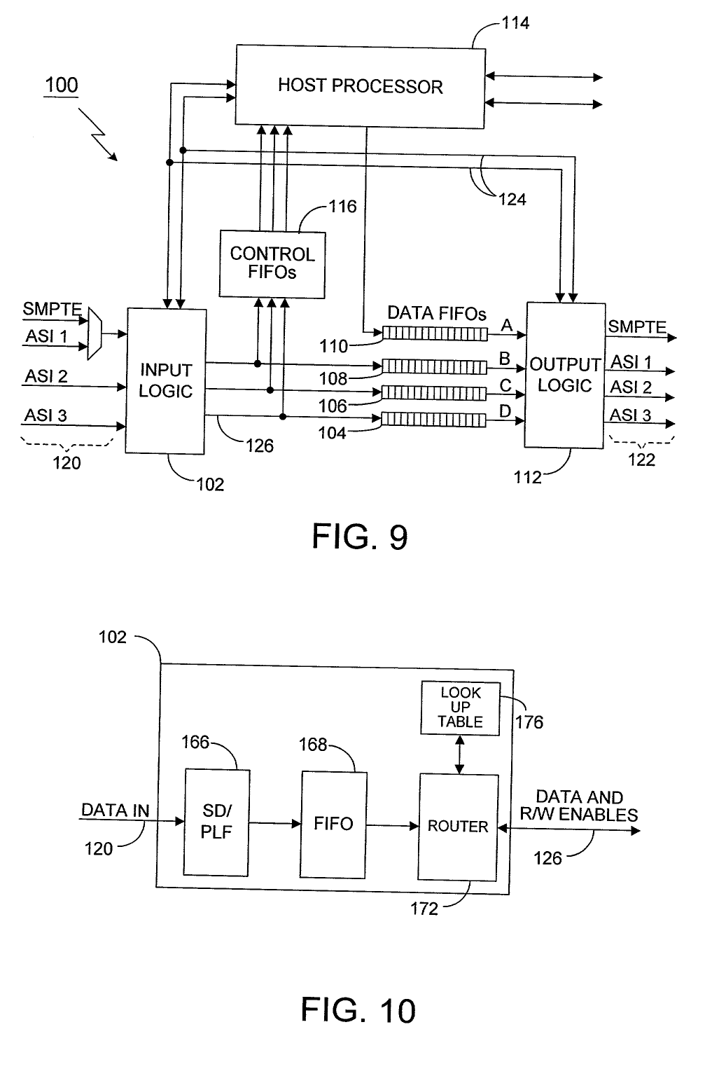

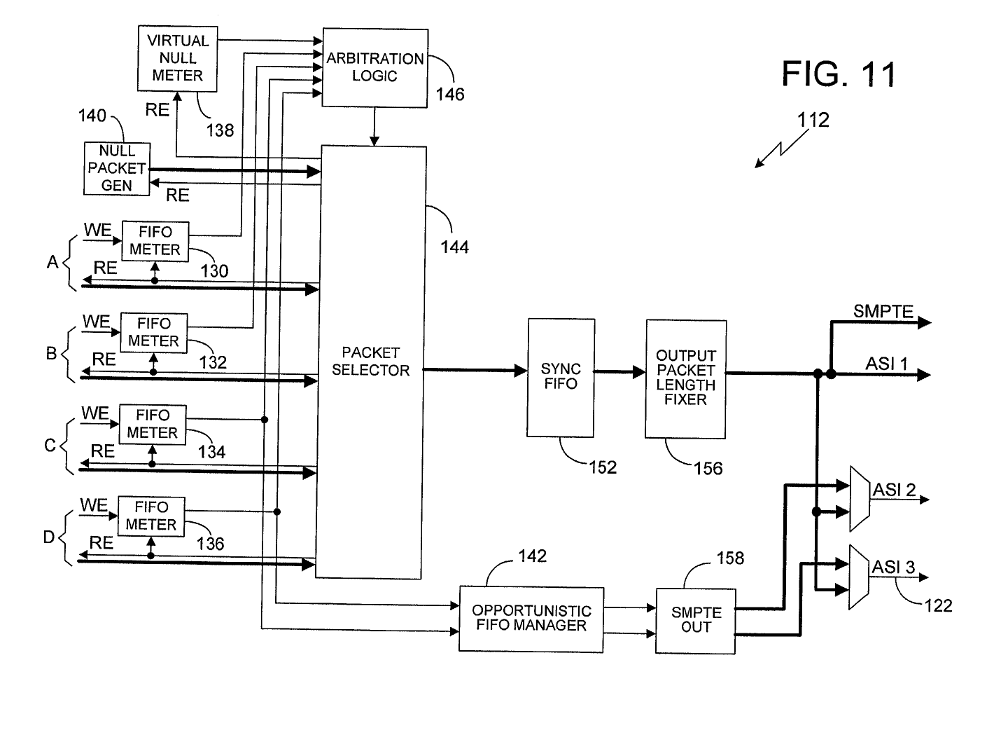

The smart FIFO meter 200 of the preferred embodiment of the present invention, illustrated in FIG. 3, may be configured to offer opportunistic data insertion as shown in FIG. 4 as well as other opportunistic data insertion rates, i.e., quality of service guarantees, including a fixed data insertion rate of FIG. 5, a maximum data insertion limit of FIG. 6, a minimum data insertion rate of FIG. 7, and a minimum null packet insertion rate of FIG. 8. The smart FIFO meter 200 may be substituted for FIFO meters of a variety of multiplexer systems including the FIFO meters 18, 36 of the basic multiplexer system as shown in FIG. 1. A preferred smart multiplexer system 100 shown in FIG. 9, incorporates the smart FIFO meter in the output logic 112, shown in detail in FIG. 11. In the illustrated output logic 112, the smart multiplexer 100 utilizes four smart FIFO meters 130, 132, 134, 136, as well as a smart virtual null meter 138 for setting an arbitration level for a null packet generator 140. The end user of a smart multiplexer system which incorporates any number of smart FIFO meters 200 may configure each smart FIFO meter 200 as desired for the quality of service guarantees. For simplicity, the following descriptions of the operation of the smart FIFO meter 200 will refer to the components of a smart multiplexer architecture of FIG. 1.

Referring to FIG. 1 and FIG. 3, the smart FIFO meter 200 of the preferred embodiment reports an arbitrary amount of data in the buffer 20, 38 to the arbitration logic 22 based upon specified criteria associated a desired quality of service guarantees, to allow the multiplexer 24 to make more profitable use of the system bandwidth. The smart FIFO meter 200 is slightly more complex than a simple FIFO meter 18, 36. Where a simple FIFO meter 18, 36 consists only of a single counter, the smart FIFO meter 200 is implemented utilizing two rate generators, MAX_RATE_GEN 218 and MIN_RATE_GEN 220, and three counters, MAX_COUNT 228, MIN_COUNT 230, and ACTUAL_COUNT 204. The counters and rate generators of the preferred embodiment may be implemented in programmable logic. In other embodiments of the invention, the counters and rate generators may be implemented in software, discrete hardware, or any combination thereof. The LQF arbitration scheme increases linearly in complexity with the number of data channels, and thus, is suitable for large numbers of input queues. A maximum of one smart FIFO meter 200 is needed for each data channel buffer 20, 38. Smart FIFO meters 200 and simple FIFO meters 18, 36 may be mixed, and under certain system configurations, it may not be necessary to implement a smart FIFO meter 200 for every data channel. When implemented in hardware, the smart FIFO meters 200 automatically provide a parallel implementation for quality of service guarantees because all modifications to buffer priorities occur simultaneously. Because of this, a multiplexer system 10 utilizing the smart FIFO meters 200 is highly scalable.

The smart FIFO meter 200 of the preferred embodiment receives read 206, write 202, and reset 210 signals as inputs. The user-specified control variables for configuring the smart FIFO meter 200 include a maximum rate 208 which sets a maximum bandwidth limit for a multiplexer channel, a minimum rate 212 which sets a minimum bandwidth guarantee for a multiplexer channel, and a flow control enable 216. The outputs of the smart FIFO meter 200 include an actual count 214, which is the actual amount of data in the buffer 20, 38, a free space 236 line which reports a fictitious amount of data in the buffer 20, 38 to the flow control 14, 32, and an arbitration level 234 line connected to the arbitration logic 22 for setting a buffer priority level.

The actual count block 204 of the smart FIFO meter 200 shown in FIG. 3 maintains a count of the actual amount of data in the buffer 20, 38. A reset 210 received by the smart FIFO meter 200 will reset the actual count output 214 to zero to indicate that the buffer 20, 38 contains no valid data. A reset may be initiated by a processor controlling the smart multiplexer 10, or by an external reset trigger, such as a system power up. When the input router 16 writes to the buffer 20, 38, a write signal 202 is received by the actual count block 204, and the actual count output 214 is incremented if the actual count is not equal to the maximum size of the buffer 20, 38. When the multiplexer 26 reads from the queue to transmit a data packet, a read signal 206 is sent to the actual count block 204, and the actual count output 214 is decremented. The actual count remains unchanged for any other condition, for example, if the read signal 206 and the write signal 202 are sent simultaneously. Table 1 shows pseudo code that represents a portion of the operation of the actual count block 204.

TABLE 1
ACTUAL COUNT Calculation

```
if reset = ‘1’
  then actual_count <═ 0;
  else if (write = ‘1’ and read = ‘0’ and actual_count /= max. buffer size)
```

then actual_count <═ actual_count + 1;
else if (read = ‘1’ and write = ‘0’ and actual_count /= 0)

then actual_count <═ actual_count − 1;

end if;

end if;
end if;

The maximum count block 228 maintains a maximum count 240 of the number of packets that would be in the buffer 20, 38 if the multiplexer were to be inserting data into the buffer 20, 38 at a user-specified maximum rate 208. A maximum rate generator block 218 provides pulses 222 to the maximum count block at a rate (duty cycle) based upon the maximum rate 208 control word. The maximum count block 228 increments the maximum count 240 for each received enabling pulse 222. When data is actually removed from the buffer queue, the maximum count block 228 receives a read signal 206, and the maximum count 240 is decremented. The maximum count block 228 will maintain the maximum count 240 at a level equal to or greater than the actual count 214. If a read signal 206 and maximum rate enable signal 222 are received at the same time, the maximum count 240 remains unchanged. Data from the buffer 20, 38 is inserted into the output data stream 26 until the maximum data rate is reached. Table 2 shows pseudo code that partially represents the operation of the maximum count block 228.

TABLE 2
MAXIMUM COUNT Calculation

```
if max_rate = ‘0’ and read = ‘1’ and max_count > actual_count
  then max_count <═ max_count − 1;
  else if (max_rate = ‘1’ and read = ‘0’ and max_count /=
  max. buffer size)
```

then max_count <═ max_count + 1;
else if max_count < actual_count

then max_count <═ actual_count;

end if;

end if;
end if;

The free space output 236 of the smart FIFO meter is connected to a flow controller 14, 32 of the buffer 18, 38 to prompt a data server 6, 8 to send more data. If a maximum rate 208 is specified, then data 64 must be maintained in the buffer in order to output the data at the maximum rate 208. The free space output 236 is equal to the maximum count output 240 less the actual count 214 as shown in Table 3. Therefore, whenever the actual count 214 is less than the maximum count output 240, the flow control 14, 32 will request data for the buffer 20, 38. This ensures that sufficient data is available to be output from the buffer 20, 38 at the desired maximum rate 208.

TABLE 3
FREE SPACE Calculation

free_space <═ max_count − actual_count

The minimum count block 230 operates in a similar manner to the maximum count block 228, except that the minimum count output 238 is constrained to be less than the actual count 214. The minimum count block 230 maintains a minimum count 230 which represents the number of packets in the buffer 20, 38 if data were to be inserted into the buffer 20, 38 at the rate specified as the minimum rate 212. The minimum count output 230 is generated from the user-specified minimum rate 212 which is input into the minimum rate generator 220. The minimum rate generator 220 produces minimum rate enable pulses 226 for the minimum count block 230. The minimum count output 238 is incremented for each minimum rate enable pulse 226 so long as the minimum count output 238 is less than or equal to the actual count 214. When data is actually removed from the buffer 20, 38, the minimum count block 230 receives a read signal 206, and the minimum count output 238 is decremented. The minimum count 238 does not fall below a count of zero since the buffer 20, 38 cannot contain a negative amount of data. If a read signal 206 and a minimum rate enable pulse 226 are received at the same time, the minimum count output 238 remains unchanged. Table 4 shows pseudo code that represents a portion of the operation of the minimum count block 230.

TABLE 4
MINIMUM COUNT Calculation

if min_rate = ‘1’ and read = ‘0’ and min_count < actual_count

then min_count <═ min_count + 1;
else if min_rate = ‘0’ and read = ‘1’ and min_count /= 0

then min_count <═ min_count − 1;
else if min_count > = actual_count

then min_count <═ actual_count;

end if;

end if;

end if;

The level select block 232 reports an arbitration level 234 to the arbitration logic 22. The level select block 232 receives inputs of a flow control enable 216 the minimum count signal 238 and the actual count signal 214. The flow control enable 216 is a user-specified input. When the flow control enable 216 is off, i.e., ‘0’, then the arbitration level 234 is equal to the actual count 214 of data in the buffer. Thus, when flow control is not enabled, the smart multiplexer 10 behaves like a traditional multiplexer with priority given to the buffer 20, 38 having the most data.

When the flow control enable 216 is on, i.e. ‘1’, and the actual count 214 is greater than or equal to the size of one network packet, the arbitration level 234 is reported as the greater of one packet or the minimum count 238. If the actual count 214 is less than one packet, the arbitration level 234 is reported as zero. Table 5 shows pseudo code that represents a portion of the operation of the level select block 232.

TABLE 5
LEVEL SELECT Calculation

if fc_enable = ‘0’

then arb_level <═ actual_count;
else if actual_count > = (a packet size)

then if min_count < (a packet size)

then arb_level <═ (a packet size);
else arb_level <═ min_count;

end if;

else arb_level <═ 0;

end if;

end if;

### Maximum Data Rate Limits

Referring to FIG. 3 and FIG. 6, a user may specify a maximum data rate 80 to limit the amount of opportunistic data 64 inserted into the non-opportunistic data stream 50. A smart multiplexer 100 of a preferred embodiment, as shown in FIG. 9, fills any remaining bandwidth with null packets 58. To guarantee a maximum data rate 80, the smart FIFO meter reports free space 236 to the flow control logic 14, 32 in order to maintain sufficient data in the buffer 20, 38 to fill the buffer to the specified maximum rate bandwidth 80. If data is read from the buffer 20, 38 at a rate less than the maximum data rate 208, then the value of the maximum count output 240 remains close to the maximum possible level of the buffer 20, 38. When the actual count 214 of the buffer is equal to the maximum count 240 or when the buffer 20, 38 is full, then free space 236 is zero and the flow control 14, 32 stops requesting data 64 from the data server 6, 8. As the opportunistic data 64 is output from the buffer 20, 38, the actual count 214 decreases below the maximum count output 240, and the free space signal 236 again prompts the a flow control 14, 32 to request more data 64 from the data server 6, 8. This process continues as long as the opportunistic data 64 output from the smart multiplexer system 10 is less than the maximum rate 208.

Free space 236 is never reported to be less than zero. Thus, if the multiplexer 24 is reading data from the buffer 20, 38 at a rate greater than the maximum data rate 208, then the maximum count output 240 and the reported free space 236 begin to decrease until the maximum count 240 is equal to the actual count. As additional data is removed from the buffer 20, 38, the maximum count block 228 sets the maximum count output 240 equal to the actual count 214, and the free space 236 reported to the flow control logic 14, 32 is zero. With flow control requests inhibited, the actual level of data in the buffer 20, 38 begins to drop, and the arbitration logic 22 reduces the priority of that buffer, thus reducing the rate that data is taken from the buffer 20, 38. When the read rate is reduced to below the maximum data rate 208, the maximum count output 240 and the free space 236 begin to rise, allowing more data 64 to be placed in the buffer 20, 38.

As the maximum count block 228 continues to ensure that the buffer has data 64 available up to the maximum rate 208, the level select block 232 sets the arbitration level output 234 to exactly one packet. As long as a non-opportunistic data buffer, e.g., video data 50, has sufficient data available to transmit a packet, the arbitration logic 22 gives priority to the video data 50. However, when the available video data 50 falls below one packet, the arbitration logic 22 gives the opportunistic data 64 buffer priority since the arbitration level 234 is reporting one packet. The buffer 20, 38 is then emptied up to the maximum data rate 208. Full opportunistic data insertion 70, such as that shown in FIG. 4, may be implemented by setting the maximum data rate 208 to the maximum available bandwidth, or to another sufficiently high number, such that the effect of the maximum rate is not perceived by the arbitration logic 22. Alternatively, the logic of the maximum count block 228 can be modified (not shown) such that the value of the maximum count output 240 may be set explicitly to the maximum size of the buffer 20, 38.

### Minimum Data Rate Guarantees

Referring to FIG. 3 and FIG. 7, a minimum data rate 90 guarantees that a certain amount of opportunistic data 64 is transmitted from the buffer 20, 38 associated with the smart FIFO meter 200 of the preferred embodiment. When the minimum data rate 212 is specified by a user, and flow control 216 is enabled, the opportunistic data of the buffer 20, 38 preempts video data 66, or opportunistic data from another channel's buffer, to ensure that the minimum data rate 90 is achieved. Any remaining bandwidth may be filled with opportunistic data 64.

By setting the user-specified minimum rate 212 to a value greater than zero, a minimum guaranteed bandwidth 90 may be reserved for a data channel. To guarantee that the minimum bandwidth 90 is used, the multiplexer 26 must remove enough data from the buffer to fill the desired bandwidth. As long as data is being read from the buffer 20, 38 faster than the minimum data rate 212, as determined by the frequency of the minimum rate enable pulses 226, the value of minimum count output 238 remains close to zero because it is being decremented at a faster rate than it is being incremented. Therefore, the level select block 232 fixes the value of arbitration level 234 at one packet, and the channel will act in the same manner as it would if the minimum rate 212 were set to zero.

If data is being read from the buffer 20, 38 at a rate less than the minimum data rate 212, the minimum count output 238 and the arbitration level 234 begin to increase until the arbitration level 234 reaches a level high enough that the arbitration logic 22 gives it priority over the other buffers, including the non-opportunistic and the opportunistic data channels. The arbitration level 234 remains at the high level until enough data has been removed from the buffer 20, 38 to bring the fill the data stream bandwidth to the proscribed minimum rate 90.

### Null Packet Insertion

Prior art multiplexers maintain a constant output bit rate by filling unused bandwidth with null packets. The smart multiplexer 100 of the preferred embodiment, as shown in FIGS. 9-11, inserts null packets utilizing a “virtual null queue” 140 which contains only null packets. The null queue 140 is controlled by a dedicated smart FIFO meter, or virtual null meter 138. If the level select 232 of the smart FIFO meter 200 always reports that the virtual null queue 140 contains exactly one packet, then the null packets are inserted into the output stream in the same manner as the “opportunistic data” as described above. However, the null packets are inserted into the output stream only if none of the other buffers 130, 132, 134, 136 of the smart multiplexer 100 contain a complete data packet. A benefit of the virtual null queue 138 is that incomplete data packets will never be read from a buffer since the null queue 138 has a higher priority than a queue with an incomplete packet.

Referring again to FIG. 3, null packets may be inserted into the data stream utilizing a smart FIFO meter 200 with flow control enabled and the minimum rate 212 set to zero. A specified minimum rate of zero inhibits the minimum rate generator 220 from pulsing. As a result, the minimum count output 238 is set to the actual count, and the level select 232 sets the arbitration level 234 at one packet.

### Minimum Null Rate

An additional quality of service guarantee provided utilizing the smart FIFO 200 of the preferred embodiment is a minimum null packet guarantee 94, as shown in FIG. 8. The null packet guarantee 94 may be inserted in addition to opportunistic data insertion 96. The guarantee of null packets 58 in the data stream is beneficial if it is necessary to insert additional data into the stream at a subsequent point in the transmission. In addition, the minimum null rate 94 is useful to provide compatibility of the smart multiplexer with systems that require a specific quantity of null packets to operate.

A minimum null rate 94 is provided by utilizing a smart FIFO meter 200 with flow control enabled and the minimum rate 212 set to a desired null rate. If null packets are being generated by the null packet generator 140 at a rate less than the minimum rate 212, then the minimum rate generator 220 pulses more often than data is removed. As a result, the minimum count output 238 is incremented more often than it is decremented, and its value will increase. The level select 232 sets the arbitration level 234 to the minimum count output 238, and the null packet generator 140 is given priority over all other buffers.

### Fixed Data Insertion Rate

FIG. 5 illustrates a fixed data rate insertion guarantee 60 that may be implemented utilizing the smart FIFO meter 200 with the flow control 216 enabled, and by specifying one of either the maximum rate 208 or the minimum rate 212, as described above. If the non-opportunistic data is known to occupy a fixed video data bandwidth 62, then a minimum rate 212 can be specified such that the video data will not be preempted. If the video data bandwidth is not known, then a specified maximum rate 208 may be a preferable configuration of the smart FIFO meter 200. It is also possible to set both a minimum rate 212 and a maximum rate 208 to constrain the output rate of a channel to fall between a desired minimum and maximum rate/bandwidth (not shown). By setting the minimum and maximum rates 212, 208 sufficiently close together, or the same value, a fixed rate insertion can be guaranteed.

### Smart Multiplexer Architecture

As discussed above, the FIFO meters 18, 36 of FIG. 1 may be substituted with smart FIFO meters 200 as shown in FIG. 3 to implement a smart transport stream multiplexer. A preferred embodiment of a smart transport stream multiplexer 100 is illustrated in FIGS. 9, 10, and 11. FIG. 9 is a top level block diagram of a smart transport stream multiplexer 100 which includes an input logic block 102, an output logic block 112 which includes smart FIFO meters 130, 132, 134, 136, the data FIFO buffers 104, 106, 108, control FIFO's 116, and the host microprocessor 114. Both the input logic 102 and the output logic 112 may be implemented with field programmable gate arrays (FPGAs), although the two may be combined into a single FPGA.

The smart multiplexer 100 multiplexes compatible input transport streams 120 into a single output transport stream 122. The smart multiplexer 100 also has the capability of selectively adding or dropping transport stream elements, such as video and audio streams, to create an output that is an arbitrary subset of the input transport stream. Through the use of data flow control, the smart multiplexer 100 has the capability of completely filling available bandwidth in a non-opportunistic transport stream without dropping transport packets of the non-opportunistic transport stream. The amount of data inserted into the transport stream output 122 varies depending upon the exact amount of free space present in the non-opportunistic transport stream.

Referring to FIGS. 9, 10 and 11, the host processor 114 and control FIFOs 116 are utilized to build up complete table information for each of the incoming data streams 120, to interface with the user to select which elements will be passed to the output stream 122, to create appropriate lookup tables 176 for the packet routers 172, and generate new table information containing accurate descriptors for the combined output stream 122. The new tables are written as transport packets into the outgoing control FIFO 110 that will be read by the packet selector block 144.

The input logic includes the Sync Detect/Packet Length Fixer 166 block (SD/PLF), a synchronous FIFO 168, a router 172 and a look up table 176. The primary responsibilities of the input logic 102 are to synchronize itself to the incoming transport stream 120, to perform packet identifier (PID) based routing of the incoming packets, and to replace PIDSs in the packets as necessary. This information is valuable in setting optimum rates of the output data 122. The SD/PLF block 166 is responsible for acquiring synchronization on incoming packets of the data streams 120, and includes a sync detection circuit with a selectable packet length (188, 204 or 208 byte packets). The FIFO 168 is a dually clocked synchronous FIFO, which performs the clock domain transition between the input and local clocks. The packet router 172 contains functions to calculate the input data rate, as well as the rate of data going to the data FIFOs 104, 106, 108 based upon the packet routing information stored in the look up table 176.

The output logic 112 is responsible for servicing the three data FIFOs 104, 106, 108 and for inserting null packets into the output data stream 122. Each data FIFO 104, 106, 108 has a smart FIFO meter 136, 134, 132. These smart FIFO meters 136, 134, 132 report the FIFO levels in bytes to the arbitration logic 146. In the preferred embodiment, the smart FIFO meters 136, 134, 132 also have a single-bit virtual empty flag that will be active whenever there is less than one data packet worth of bytes in its associated data FIFO 104, 106, 108. All outputs of the smart FIFO meters 136, 134, 132 are passed to the arbitration logic block 146 except when redundant data servers are used, in which case the FIFO meter outputs are fed to a redundancy logic (not shown), and the redundancy logic feeds the arbitration logic 146.

The packet selector 144 is a multiplexer which is constrained to switch between data buffers 104, 106, 108, 110 only on packet boundaries. Shortly before the end of each packet, the packet selector 144 queries the arbitration logic block 146 as to the identity of the next data source. The null packet generator 140, as discussed above, is a virtual buffer of null packets. Null packets are inserted into the output data stream 120 when the arbitration logic 146 determines that the virtual null meter 138 has a highest priority. The packet selector 144, the null packet generator and meter 140, 138 and the arbitration logic 146 can always service read (RE) enables by inserting null packets when there is no data available in the data FIFOs 104, 106, 108, 110.

The virtual null meter 138 provides a guaranteed minimum of null packets in opportunistic mode. A “virtual” packet source is created with a fixed data input rate. The virtual null meter 138 is simply a smart FIFO meter with flow control always enabled and the maximum rate limit set to a value such that there is no effective limit on null packets which may be produced. The virtual null meter 138 is decremented during reads. The null packet generator 140 is also “virtual” in the sense that no actual packet data is stored. Instead, when the null packet generator 140 receives a read signal from the packet selector 144, it generates a new null packet for output.

The arbitration logic 146 collects information on the data levels of the FIFOs 104, 106, 108 from the FIFO meters 136, 134, 132, and informs the packet selector 144 which source to service. The selection of a buffer for a read enable is based upon the mode of the smart multiplexer 100. The modes of the smart multiplexer 100 include equal-opportunity mode or opportunistic mode. The arbitration logic 146 always uses the LQF algorithm. In equal-opportunity mode, the smart nature of all of the FIFO meters is disabled. In the opportunistic mode, one or more of the smart FIFO meters has flow control enabled.

The sync FIFO 152 is a singly clocked synchronous FIFO which feeds the transport data stream to the output packet length fixer (OPLF) 156. The OPLF 156 operates in one of two modes. For a SMPTE 31OM output mode, it is driven by byte enables from the SMPTE 31OM out block 158 and outputs 188 byte packets (not shown). For ASI output, the OPLF 156 uses its own variable byte rate generator (not shown) to create byte enables which travel forward to the ASI output.

During normal operation of the smart multiplexer system 100, the output logic 112 services a number of buffers 104, 106, 108, 110 each containing some number of packets. If all data sources are known to be non-opportunistic, the arbitration logic 146 directs the packet selector 144 to service the buffer with the most packets. If no buffers contain a full packet, null packets are issued from the null packet generator 140. If one of the buffers 104, 106, 108, 110 is defined to be opportunistic, the smart FIFO meter 136, 134, 132, 130 hides the true number of packets in the buffer from the arbitration logic 146 and reports the presence of only a single packet in the opportunistic buffer. All other buffers are serviced based on which has the most packets waiting. If none of the fixed rate buffers contain a full packet, then, and only then, will a packet be issued from the opportunistic buffer. If the opportunistic buffer is also empty, a null packet will be issued. A separate opportunistic FIFO manager (OFM) 142 attempts to maintain a minimum number of packets in the opportunistic buffers. It monitors the free space levels reported by the smart FIFO meters, and sends packet request messages to the data servers if the levels drop too low.

Although an exemplary embodiment of the invention has been described above by way of example only, it will be understood by those skilled in the field that modifications may be made to the disclosed embodiment without departing from the scope of the invention, which is defined by the appended claims.

I CLAIM:

1. A buffer meter for monitoring a data level of data in a buffer and for outputting an arbitration level signal for prompting the data to be read from the buffer, the buffer meter comprising:
an actual count counter for monitoring the data level in the buffer, the actual count counter having an actual count output;
a minimum rate counter for generating a minimum count output, the minimum count output for guaranteeing a minimum rate of reading the data from the buffer;
a maximum rate counter for generating a maximum count output, the maximum count output for limiting the data read from the buffer to a maximum rate; and
a level select means for determining a value of the arbitration level signal based upon the actual count output, the minimum count output and a flow control enable input.

2. The buffer meter of claim 1, further comprising a maximum rate generator for outputting a plurality of maximum rate enable pulses at the maximum rate to the maximum rate counter, wherein the maximum count output is incremented for each maximum rate enable pulse and decremented for a read of the data buffer.

3. The buffer meter of claim 2, further comprising a free space output for prompting a data server to send more data to the buffer, the free space output calculated from the maximum count output less the actual count output, the free space output having an upper limit of a data capacity of the buffer.

4. The buffer meter of claim 3, wherein the maximum count output is constrained to be greater than or equal to the actual count output.

5. The buffer meter of claim 1, wherein the maximum rate is a first user-specified input.

6. The buffer meter of claim 1, further comprising a minimum rate generator for outputting a plurality of minimum rate enable pulses at the minimum rate to the minimum rate counter, wherein the minimum count output is incremented for each minimum rate enable pulse and decremented for a read of the data buffer.

7. The buffer meter of claim 1, wherein the minimum rate is a second user-specified input.

8. The buffer meter of claim 6, wherein the minimum count output is constrained to be less than or equal to the actual count output.

9. The buffer meter of claim 1, wherein the value of the arbitration level signal is set to the actual count output when the flow control enable input is disabled; wherein the value of the arbitration level signal is set to a data packet size when the flow control enable input is enabled and the actual count output is greater than or equal to the data packet size and the minimum count output is less than the data packet size; and wherein the value of the arbitration level signal is set to the minimum count output when the flow control enable input is enabled and the actual count output is greater than or equal to the data packet size and the minimum count output is greater than or equal to the data packet size.

10. The buffer meter of claim 1, wherein the buffer meter is implemented in one of software, hardware, and a combination of software and hardware.

11. A method for controlling data flow from a buffer of a plurality of buffers connected to a multiplexer, the multiplexer reading the buffer based upon an arbitration level received from a buffer meter monitoring the buffer, the method comprising the steps of:
setting a flow control input of the buffer meter to one of an enable state and a disable state;
generating a minimum count for guaranteeing a minimum rate of reading data from the buffer;
generating a maximum count for limiting the data read from the buffer;
generating an actual count of data in the buffer; and
generating the arbitration level based upon the actual count, the minimum count and the flow control input.

12. The method of claim 11, wherein the step of generating the arbitration level further comprises the steps of:
setting the arbitration level to the actual count if the flow control input is set to the disable state;
setting the arbitration level to a data packet size if the flow control input is set to the enable state and the actual count is greater than or equal to the data packet size and the minimum count is less than the data packet size; and
setting the arbitration level to the minimum count if the flow control input is set to the enable state and the actual count output is greater than or equal to the data packet size and the minimum count output is greater than or equal to the data packet size.

13. The method of claim 11 wherein the step of generating the minimum count further comprises the steps of:
generating a plurality of minimum rate pulses based upon the minimum rate;
incrementing the minimum count for each minimum rate pulse if minimum count is less than the actual count;
decrementing the minimum count for each read of the buffer if minimum count is greater than a value of zero; and
setting the minimum count to the actual count if minimum count is greater than or equal to the actual count.

14. The method of claim 11 wherein the step of generating the maximum count further comprises the steps of:
generating a plurality of maximum rate pulses based upon a desired maximum rate;
decrementing the maximum count for each read of the buffer if maximum count is greater than the actual count;
incrementing the maximum count for each maximum rate pulse if the maximum count is less than a size of the buffer; and
setting the maximum count to the actual count if the maximum count is less than the actual count.

15. A multiplexer system for implementing a plurality of quality of service guarantees for the transmission of data from a plurality of data channels, the multiplexer system comprising:
the plurality of data channels for outputting packets of data, each data channel comprising:
an input means for accepting and requesting data from a data server;
a buffer for holding the accepted data;
a smart meter for generating an arbitration level, the smart meter comprising:
a flow control enable input;
an actual count output of a data level in the buffer;
a reported free space output connected to the input means, wherein the input means requests data from the data server to fill the buffer based upon the reported free space output;
a minimum count output for guaranteeing a minimum rate of reading data from the buffer; and
a level select means for determining a value of the arbitration level based upon the actual count output, the minimum count output and the flow control enable input;
an arbitration logic means for selecting a data channel of said plurality of data channels based upon the arbitration level; and
a multiplexer controlled by the arbitration logic means, the multiplexer selecting and transmitting data from the buffer of the selected data channel.

16. The multiplexer system of claim 15, wherein the smart meter is implemented in one of software, hardware, and a combination of software and hardware.

17. The multiplexer system of claim 1 5, wherein the plurality of quality of service guarantees comprises a fixed opportunistic data rate insertion guarantee, a maximum data rate insertion limit, a minimum data rate insertion guarantee, and a minimum null rate insertion guarantee.

18. The multiplexer system of claim 17, wherein the minimum count output is generated from a user-specified minimum rate input, the user-specified minimum rate input for implementing the minimum data rate insertion guarantee.

19. The multiplexer system of claim 15, further comprising:
a virtual null buffer for outputting null data packets; and
a virtual null meter connected to the arbitration logic means, the virtual null meter for generating a null buffer arbitration level;
wherein the null buffer arbitration level provides a minimum null rate insertion guarantee of null data packets from the virtual null buffer.

20. The multiplexer system of claim 15, wherein the reported free space output is generated based upon a user-specified maximum rate input and the actual count output, the user-specified maximum rate input utilized for implementing the maximum data rate insertion limit.
